(19) United States
(12) Patent Application Publication
(10) Pub. No.: US 2008/0201465 A1
(43) Pub. Date: Aug. 21, 2008

(54) Centralized Monitoring of Distributed Systems

(75) Inventors: Dustin Jones, Redmond, WA (US); Tom Keane, Seattle, WA (US); Lorenzo Rizzi, Kirkland, WA (US); Ian Jirka, Snoqualmie, WA (US); Ferit Findik, Sammamish, WA (US); Murat Ersan, Redmond, WA (US); Jakub Oleksy, Redmond, WA (US); Lee H. Chang, Redmond, WA (US); Vitaly Voloshin, Issaquah, WA (US); Nadir Ahmed, Redmond, WA (US); Sandy Phadke, Bellevue, WA (US); Anandha Ganesan, Redmond, WA (US); Joel Pothering, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/675,785

(22) Filed: Feb. 16, 2007

(51) Int. Cl. G06F 15/173

(52) U.S. Cl. 709/224; 709/223

(57) ABSTRACT

A remote server managing multiple client computers at a customer site communicates with a server at a service provider site. A proxy gateway at the remote server allows communications through a network to the server at the service provider site. Remote monitoring of the multiple client computers may be performed at the server at the service provider site through a central monitoring console.

### BACKGROUND

Customers often outsource the maintenance and operations aspects of information technology (IT) related functions for the purposes of saving money or leveraging external expertise. This may also be true in monitoring scenarios, where customers outsource monitoring of their environments to IT specialists and service providers. Typically, for entities providing such monitoring services, two approaches or monitoring system topologies may be available.

In a first approach, a service provider could manage a customer's environment remotely using either agent or agentless monitoring technology, with no local management server or device between the customer's environment and the service provider's monitoring center. This approach has several technical and administrative problems. Even with just a few customers that have a few hundred systems, the amount of systems that would need to be remotely monitored can quickly grow into thousands of systems and can require additional personnel and equipment to monitor these systems. Securing the connectivity between the customer and the service provider could also be complex in this scenario. An expensive virtual private network (VPN) may be needed between each customer and the service provider. If this VPN connection stopped working, the customer's system would not be able to be monitored by the service provider.

In a second approach, a service provider can install a management server at the customer's premises and remotely administer and monitor the customer's systems using the management server. This solution has its own complexities and costs. The service provider may be required to maintain a unique set of credentials for each customer. These credentials may need to be changed regularly to ensure the credentials remain secure. This approach also may require that configuration of management policies to be performed per customer, where management policies determine how systems and service are to be monitored. The duplication of effort increases each time a new customer is added.

These approaches, and others, can be expensive to manage and inhibit the service provider's ability to scale. In other words, as more customers are added, the service provider may have to hire additional employees to manage the additional agents and management servers. Furthermore, such solutions may not provide a holistic view of the overall health of all customers, while simultaneously providing customer-centric views that can be used when troubleshooting an issue at a single customer. A better solution is needed that allows the service provider to remotely manage many customers without the need for an expensive VPN or credential management, while giving the service provider the ability to customize the level and types of services being provided to the customer.

### SUMMARY

This summary is provided to introduce simplified concepts of centralized monitoring of distributed systems, which is further described below in the Detailed Description. This Summary is not intended to identify essential features of the claimed subject matter nor is it intended for use in determining the scope of the claimed subject matter.

In an embodiment, at a service provider site, an application may be installed that manages and provides data as to particular customer site, and at the customer site a remoting application is installed that provides communication with the service provider site.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

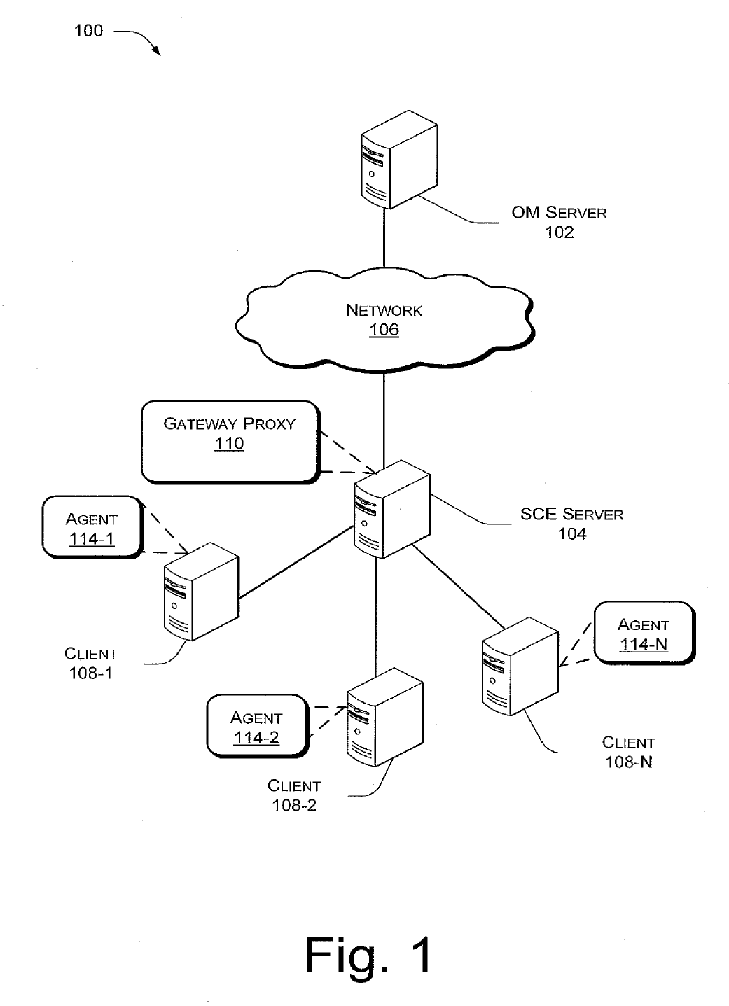

FIG. 1 is an illustration of an exemplary environment in which centralized monitoring of distributed systems may be implemented.

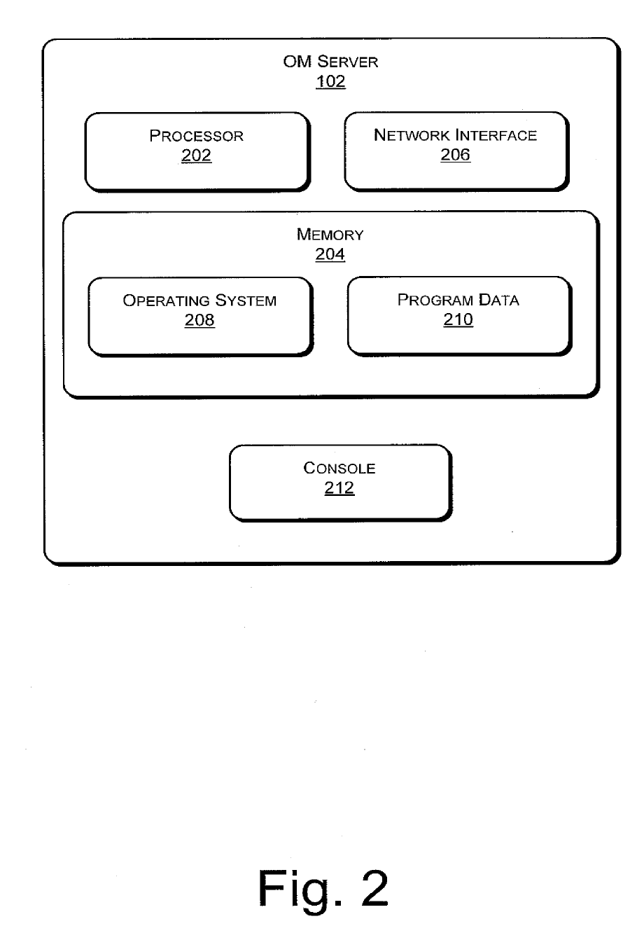

FIG. 2 is an implementation of an Operations Manager (OM) Server in one embodiment.

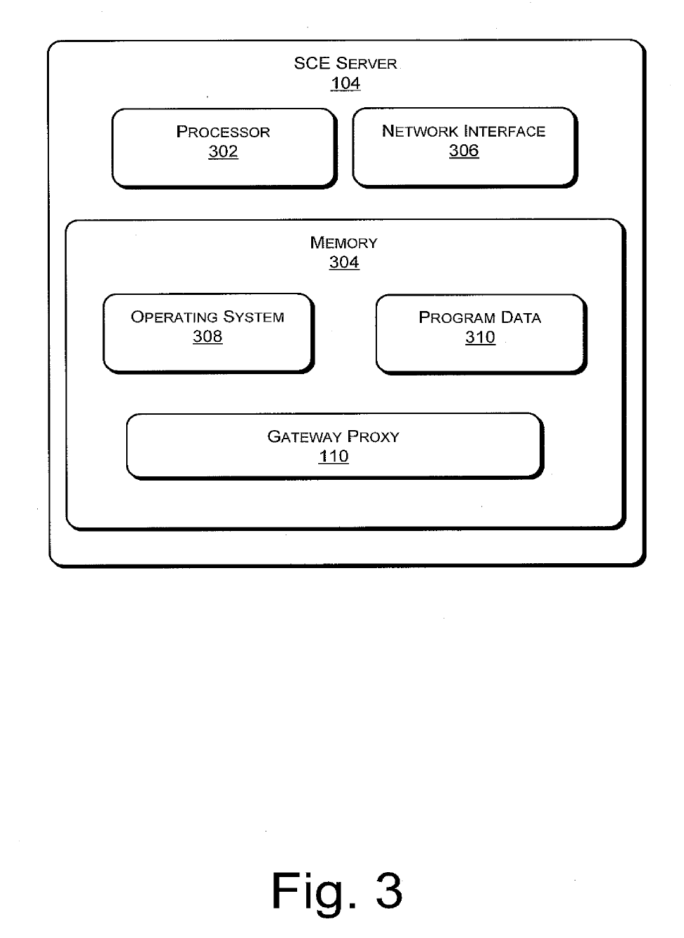

FIG. 3 is an implementation of a System Center Essentials (SCE) Server in one embodiment.

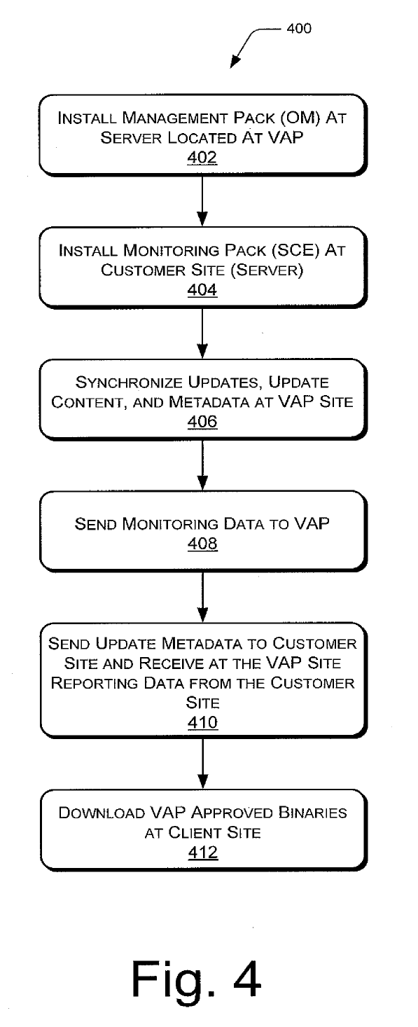

FIG. 4 is an illustration of an exemplary method for updating a system for centralized monitoring.

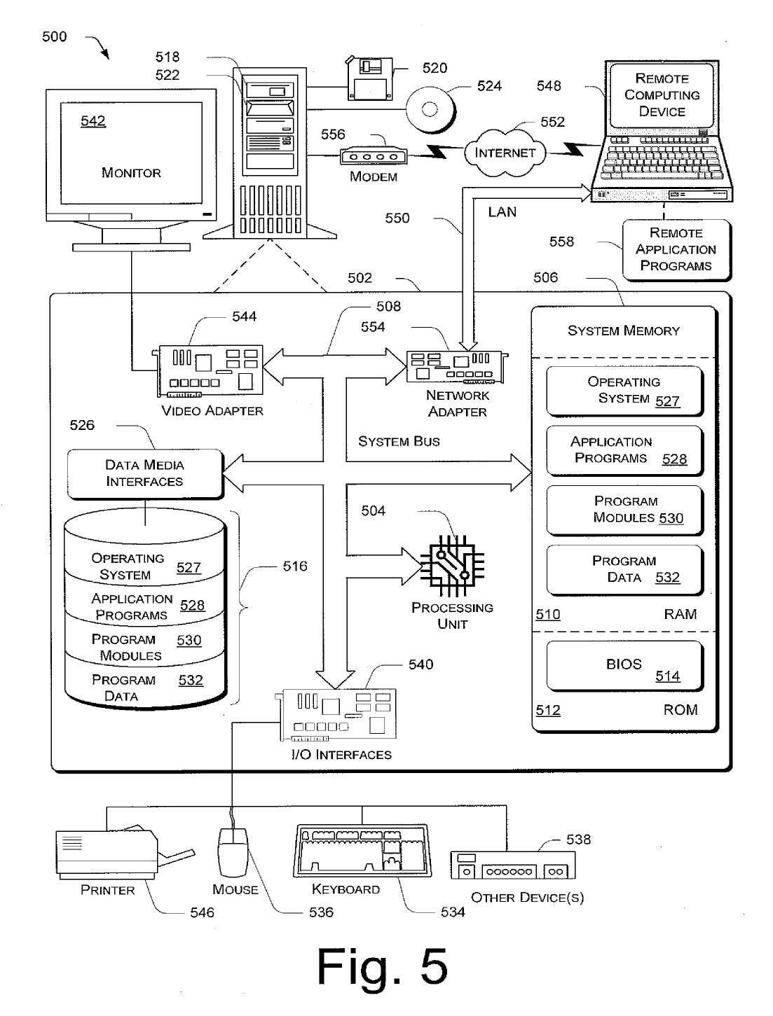

FIG. 5 is an illustration of an exemplary computing environment for the implementation of the exemplary system and method for centralized monitoring of distributed systems over a network.

### DETAILED DESCRIPTION

The following disclosure describes systems and methods for centralized monitoring of distributed systems over a network, such as the Internet. More particularly, the techniques involve a gateway health service proxy that integrates a remote management device or server, with a server managed by a service provider. In a particular embodiment, the remote management server implements System Center Essentials (SCE) by the Microsoft® Corporation (i.e., a SCE server), and the server managed by the service provider is a server that implements Operations Manager (OM) by the Microsoft® Corporation (i.e., an OM server).

The gateway health service proxy which may be part of the SCE server, and allows the service provider to use the OM server as central monitoring console. In an implementation, the OM server provides the service provider with a holistic view of the overall health of all customers and with customer-centric views related to each customer. Thus, the service provider is permitted to remotely manage many customers and at the same time customize the level and types of services being provided to the customer. Further, the gateway health service proxy reduces the burden of maintaining credentials for each customer site.

While aspects of described systems and methods for centralized monitoring of distributed systems can be implemented in any number of different computing systems, environments, and/or configurations, embodiments are described in the context of the following exemplary system architectures.

### Exemplary Environment

FIG. 1 shows an exemplary environment 100 in which centralized monitoring of distributed systems may be implemented. For discussion purposes, environment 100 includes an Operations Manager (OM) server 102 linked to one or more System Center Essentials (S CE) servers 104 through a network 106. As discussed above the OM server 102 is a service provider managed server, and the SCE server(s) 104 is a remote management server.

For illustration purposes, the OM server 102 is shown as being associated with one SCE server 104. However, it can be appreciated that the OM server 102 may be associated with more than one SCE servers 104. Furthermore, although one OM server 102 is illustrated, it should be appreciated that the OM server 102 can be part of a group of, or multiple servers. Each SCE server 104 is further associated with one or more clients 108 (108-1, 108-2 . . . 108-N).

The network 106 may be a wireless or a wired network, or a combination thereof. The network 106 can be a collection of individual networks, interconnected with each other and functioning as a single large network (e.g., the Internet or an intranet). Examples of such individual networks include, but are not limited to, Local Area Networks (LANs), Wide Area Networks (WANs), and Metropolitan Area Networks (MANs).

The clients 108 may be implemented as any of a variety of conventional computing devices, including, for example, a server, a desktop PC, a notebook or portable computer, a workstation, a mainframe computer, a mobile computing device, a network device etc.

In an exemplary implementation, the OM server 102 is located at a service provider service provider site. The OM server 102 centrally monitors the health of all customer sites serviced by the service provider using a SCE server 104 at each customer site. The SCE server 104 in turn manages and monitors all the clients 108 at the respective customer site.

In this example, the SCE server 104 uses a gateway health service proxy (gateway proxy) 110 to communicate with the OM server 102. The gateway proxy 110 allows the service provider to use the OM server 102 as its central monitoring console, with SCE server 104 acting as a remote monitoring and management device installed at a customer's location or site.

The gateway proxy 110 may also use certificates to authenticate the service provider to the SCE server 104, thus reducing the administrative burden of maintaining credentials for each customer or customer site. Furthermore, this use of certificates can allow the service provider to remotely administer all of its customers' systems without entering a password. In addition, remote diagnostics and configuration of individual systems at a customer or customer site is possible using this capability.

Furthermore, the SCE server 104 may deploy agents 114 (114-1, 114-2, . . . 114-N) at the clients 108. The agents 114 assist in remote management and monitoring of the respective clients 108.

In an exemplary implementation, all the SCE servers 104 are connected to a OM server 102. The OM server 102 provides holistic views of all customers' health to the service provider. In addition, the OM server 102 may aggregate the health status of all the clients 108 managed by a SCE server 104 into a health status for the entire client set at a customer site. This provides a customer-centric view to the service provider through the OM server 102.

In an implementation, the OM server 102 may run various management monitoring tasks on any of the clients 108 managed by the SCE server 104 via the gateway proxy 110. For example, start-up services may be managed on one or more of the clients 108 through the agents 114.

In addition, the use of a centralized management and monitoring system as described above, can reduces the duplication of effort, while still giving the service provider the flexibility to customize its services and levels of service to each customer. For example, one management policy could be applied to all customers, and at the same time a unique policy could be applied to just a single customer.

Furthermore, the gateway proxy 110 enables customer-centric reporting through the OM server 102. For example, the service provider through the OM server 102 can send each of its customers a daily health report that show the customer the health status of each of the services and systems. This enables the service provider to support large numbers of customers, where each customer may have their own unique environment and requirements, without adding complexity or cost each time an additional customer signs up for its services.

### Exemplary Operations Manager Server

FIG. 2 shows an OM server 102 according to one embodiment. In certain implementations, the OM server 102 may be part of or include other server functions. For example, the OM server 102 may be integrated, connected to, configured with, etc. to a Microsoft® Operations Manager (MOM) server and/or a Windows® Server Update Services (WSUS) server. The MOM server and WSUS may further have distinct consoles or interfaces that are available to user (i.e., service provider).

Accordingly, the OM server 102 includes one or more processors 202 coupled to a memory 204. Such processors could be for example, microprocessors, microcomputers, microcontrollers, digital signal processors, central processing units, state machines, logic circuitries, and/or any devices that manipulate data based on operational instructions. The processor 202 is configured to fetch and execute computer-program instructions stored in the memory 204. Such memory 204 includes, for example, one or more combination(s) of volatile memory (e.g., RAM) and non-volatile memory (e.g., ROM, Flash etc.). The memory 204 stores computer executable instructions and data for centralized monitoring of distributed systems. A network interface 206 provides the OM server 102 with the capability to interface with one or more SCE servers 104 via network 106.

In one implementation, the memory 204 stores an operating system 208 and program data 210. The operating system 208 provides a platform for executing applications on the OM server 102. The program data 210 stores information generated during the execution of various applications.

The OM server 102 may also include one or more consoles 212. In certain implementations, the one or more consoles 212 is included in the memory 204. As an example, consoles 212 can include a MOM console and a WSUS console. In an exemplary operation, the WSUS console and the MOM console assist in remotely managing and monitoring the SCE servers 104 at customer sites. In one embodiment, the MOM console 214 can organize data from all the clients 108 that are monitored and managed by the gateway proxy 110 at a customer site to provide a customer-centric view.

As discussed above, in an exemplary implementation, the OM server 102 provides both holistic and customer centric-views of client health status to the service provider. The service provider may then customize services and levels of service to each customer site. For example, one management policy could be applied to all customer sites, and at the same time a unique policy could be applied to a single or a group of customer(s). Further, the service provider can send periodic health reports to each or some of its customers that show the customers the health status of each of the services and clients at the customer site.

### Exemplary System Center Essential Server

FIG. 3 shows a SCE server 104 according to an embodiment. Accordingly, the SCE server 104 includes one or more processors 302 coupled to a memory 304. Such processors could be, for example, microprocessors, microcomputers, microcontrollers, digital signal processors, central processing units, state machines, logic circuitries, and/or any devices that manipulate data based on operational instructions. The processors are configured to fetch and execute computer-program instructions stored in the memory 304. Such memory 304 includes, for example, one or more combination(s) of volatile memory (e.g., RAM) and non-volatile memory (e.g., ROM, Flash etc.). The memory 304 stores computer executable instructions and data for implementing centralized monitoring of distributed systems.

In an exemplary implementation, the memory 304 stores operating system 308 that provides a platform for executing applications on the SCE server 104 and program data 310 that stores information generated during the execution of various applications. A network interface 306 provides the SCE server 104 with the capability to interface with the OM server 102 via network 106. The memory 304 further stores a gateway health service proxy (gateway proxy) 110.

In one implementation, the SCE server 104 manages and monitors all the clients 108 at a respective customer site through agents 114. As discussed above, the gateway proxy 110 may communicate across the network 106 with the OM server 102 using a protocol that is encrypted using certificates. Certificates are also used to authenticate the service provider to the SCE server 104, thus reducing the burden of maintaining credentials for each customer site.

Further, the gateway proxy 110 assists in remote diagnostics and configuration of individual clients 108 at a customer site. In addition, the gateway proxy 110 allows the service provider to customize services and levels of service to each customer site. Moreover, the gateway proxy 110 enables customer-centric reporting by providing data regarding health status of each of the clients 108 monitored by the gateway proxy 110.

In one implementation, the SCE server 104 at a customer site is configured to communicate with the OM server 102 at a service provider site via the gateway proxy 110. The OM server 102 manages and monitors the clients 108 associated with the SCE server 104 using agents 114. Methods for centralized monitoring of distributed systems will now be described in more detail.

### Exemplary Methods

Exemplary methods for centralized monitoring of distributed systems are described. These exemplary methods may be described in the general context of computer executable instructions Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 4 illustrates an exemplary method 400 for updating a system, such as system 100, for centralized monitoring as described above. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 402, a management pack such Operations Manager (OM) management pack is installed at a service provider site or server. In certain implementations, the management pack may be part of, or included in to support, one or more servers such as a Microsoft® Operations Manager (MOM) server or Windows® Server Update Services (WSUS) server. In particular, the management pack provides customer centric data, such as views, tasks, and reports. In certain cases, MOM is installed along with a MOM data warehouse at the service provider site server In addition when the service provider site or server is configured, a certificate authority may be established at the service provider site or server. The management pack may further define tasks, vies, and reports.

At block 404, a remoting application such as Systems Center Essentials (SCE) is installed at a customer site, and particular installed on a server such a SCE server 104 described above. The remoting application (i.e., the SCE) is configured to communicate with the service provider site. The communication may be performed through a gateway proxy, such as gateway proxy 110 described above, at the SCE server. In addition, during this customer setup, service provider mode global settings may be defined.

At block 406, synchronizing is performed at the service provider site with a provider, where the provider can be a third party such as an update center. In particular, the provider sends update metadata to the service provider site. In addition, the management pack or packs described above may be sent from the provider.

At block 408, monitoring data is sent from the customer site to the service provider site. In certain embodiments, the monitoring data is sent through a dedicated channel or preexisting channel, such as a MOM channel. In addition, the service provider may open a remote console to the customer. During the monitoring, client computers may be discovered for monitoring by the customer site and the service provider site. Furthermore, the service provider site may approve the customer site for monitoring.

At block 410, update metadata is sent to the customer site and reporting summary from the customer site is sent to the service provider site. This updated metadata and reporting summary may be sent using a dedicated or preexisting channel such as a WSUS channel.

At block 412, the customer site may download binaries directed to health or status, where the binaries are approved and/or provided by the service provider site. The binaries may be installed at clients, such as clients 108, at the customer site. Furthermore, management packs may be sent to agents of the clients, and the service provider management pack may dynamically group the clients.

### Exemplary Computer Environment

FIG. 5 illustrates an exemplary general computer environment 500, which can be used to implement the techniques described herein, and which may be representative, in whole or in part, of elements (e.g., OM server 102, SCE server 104, and clients 108) described herein. The computer environment 500 is only one example of a computing environment and is not intended to suggest any limitation as to the scope of use or functionality of the computer and network architectures. Neither should the computer environment 500 be interpreted as having any dependency or requirement relating to any one or combination of components illustrated in the example computer environment 500.

Computer environment 500 includes a general-purpose computing-based device in the form of a computer 502. Computer 502 can be, for example, a desktop computer, a handheld computer, a notebook or laptop computer, a server computer, a game console, and so on. The components of computer 502 can include, but are not limited to, one or more processors or processing units 504, a system memory 506, and a system bus 508 that couples various system components including the processor 504 to the system memory 506.

The system bus 508 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 502 typically includes a variety of computer readable media. Such media can be any available media that is accessible by computer 502 and includes both volatile and non-volatile media, removable and non-removable media.

The system memory 506 includes computer readable media in the form of volatile memory, such as random access memory (RAM) 510, and/or non-volatile memory, such as read only memory (ROM) 512. A basic input/output system (BIOS) 514, containing the basic routines that help to transfer information between elements within computer 502, such as during start-up, is stored in ROM 512. RAM 510 typically contains data and/or program modules that are immediately accessible to and/or presently operated on by the processing unit 504.

Computer 502 may also include other removable/non-removable, volatile/non-volatile computer storage media. By way of example, FIG. 5 illustrates a hard disk drive 516 for reading from and writing to a non-removable, non-volatile magnetic media (not shown), a magnetic disk drive 518 for reading from and writing to a removable, non-volatile magnetic disk 520 (e.g., a “floppy disk”), and an optical disk drive 522 for reading from and/or writing to a removable, non-volatile optical disk 524 such as a CD-ROM, DVD-ROM, or other optical media. The hard disk drive 516, magnetic disk drive 518, and optical disk drive 522 are each connected to the system bus 508 by one or more data media interfaces 526. Alternately, the hard disk drive 516, magnetic disk drive 518, and optical disk drive 522 can be connected to the system bus 508 by one or more interfaces (not shown).

The disk drives and their associated computer-readable media provide non-volatile storage of computer readable instructions, data structures, program modules, and other data for computer 502. Although the example illustrates a hard disk 516, a removable magnetic disk 520, and a removable optical disk 524, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 516, magnetic disk 520, optical disk 524, ROM 512, and/or RAM 510, including by way of example, an operating system 527, one or more application programs 528, other program modules 530, and program data 532. Each of such operating system 527, one or more application programs 528, other program modules 530, and program data 532 (or some combination thereof) may implement all or part of the resident components that support the distributed file system.

A user can enter commands and information into computer 502 via input devices such as a keyboard 534 and a pointing device 536 (e.g., a “mouse”). Other input devices 538 (not shown specifically) may include a microphone, joystick, game pad, satellite dish, serial port, scanner, and/or the like. These and other input devices are connected to the processing unit 504 via input/output interfaces 540 that are coupled to the system bus 508, but may be connected by other interface and bus structures, such as a parallel port, game port, or a universal serial bus (USB).

A monitor 542 or other type of display device can also be connected to the system bus 508 via an interface, such as a video adapter 544. In addition to the monitor 542, other output peripheral devices can include components such as speakers (not shown) and a printer 546 which can be connected to computer 502 via the input/output interfaces 540.

Computer 502 can operate in a networked environment using logical connections to one or more remote computers, such as a remote computing-based device 548. By way of example, the remote computing-based device 548 can be a personal computer, portable computer, a server, a router, a network computer, a peer device or other common network node, and the like. The remote computing-based device 548 is illustrated as a portable computer that can include many or all of the elements and features described herein relative to computer 502.

Logical connections between computer 502 and the remote computer 548 are depicted as a local area network (LAN) 550 and a general wide area network (WAN) 552. Such networking environments are commonplace in offices, enterprise-wide computer networks, intranets, and the Internet.

When implemented in a LAN networking environment, the computer 502 is connected to a local network 550 via a network interface or adapter 554. When implemented in a WAN networking environment, the computer 502 typically includes a modem 556 or other means for establishing communications over the wide network 552. The modem 556, which can be internal or external to computer 502, can be connected to the system bus 508 via the input/output interfaces 540 or other appropriate mechanisms. It is to be appreciated that the illustrated network connections are exemplary and that other means of establishing communication link(s) between the computers 502 and 548 can be employed.

In a networked environment, such as that illustrated with computing environment 500, program modules depicted relative to the computer 502, or portions thereof, may be stored in a remote memory storage device. By way of example, remote application programs 558 reside on a memory device of remote computer 548. For purposes of illustration, application programs and other executable program components such as the operating system are illustrated herein as discrete blocks, although it is recognized that such programs and components reside at various times in different storage components of the computing-based device 502, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

The above-described methods and system describe centralized monitoring of distributed systems. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A server computer comprising:
a processor;
a memory controlled by the processor;
a interface controlled by the processor which accesses the memory, wherein the interface communicates with one or more remote client computers, and
a console communicating with the interface, wherein the console remotely manages the one or more remote client servers.

2. The server computer of claim 1 wherein the server computer provides a holistic customer-centric view of the one or more remote client servers.

3. The server computer of claim 1, wherein the one or remote client servers are part of a customer site, and the server computer provides particular services and levels of services to the customer site.

4. The server computer of claim 1 wherein the interface communicates to the one or more client servers through a network using a protocol that is encrypted with certificates.

5. The server computer of claim 1, wherein the console comprises one or more consoles which organize data from the one or more remote client servers.

6. The server computer of claim 1, wherein the server computer sends periodic health reports to a client site of the one or more remote client servers.

7. A server computer comprising:
a processor;
a memory controlled by the processor; and
a gateway proxy stored on the memory, wherein the gateway proxy communicates to a service provider server computer, and wherein the server computer manages one or more client computers and the gateway proxy allows the service provider server computer to monitor the health of the one or more client computers.

8. The server computer of claim 7, wherein the gateway proxy communicates to the service provider server computer using a protocol that is encrypted using certificates.

9. The server computer of claim 8, wherein the certificates are used to authenticate a service provider server computer to a gateway proxy of the service provider server computer.

10. The server computer of claim 8, wherein the certificates allow the service provider server computer to remotely administer the one or more client computers.

11. The server computer of claim 7, wherein the gateway proxy allows the service provider server computer to configure the one or more client computers.

12. The server computer of claim 7, wherein the gateway proxy enables customer-centric reporting by providing data regarding the health status of the one or more client computers.

13. The server computer of claim 7, wherein the health of the one or more client computers is monitored through agents installed in the one or more client computers.

14. A method comprising:
installing a management pack at a service provider site, wherein the management pack provides customer-centric data;
installing a remoting application at a customer site, wherein the remoting application communicates with the service provider site;
synchronizing with a provider by the service provider site, wherein the provider sends update metadata for the service provider site and the customer site.

15. The method of claim 14, wherein the customer-centric data includes views, tasks, and reports.

16. The method of claim 14, wherein the installing the management pack includes configuring the service provider site and establishing a certificate authority at the service provider site.

17. The method of claim 14, wherein installing a remoting application includes installing a gateway proxy at the customer site, wherein the gateway proxy communicates with the service provider.

18. The method of claim 14 further comprising sending monitoring data from the customer site to the service provider site.

19. The method of claim 14 further comprising sending update metadata from the service provider site to the customer site, and sending a reporting summary from the customer site to the value added provider site.

20. The method of claim 14 further comprising downloading binaries at the customer site, wherein the binaries are directed to health status of client computers of the customer site.
